(19) United States
(12) Patent Application Publication
(10) Pub. No.: US 2026/0054337 A1
(43) Pub. Date: Feb. 26, 2026

(54) ADAPTIVE CURVED SURFACE SUPPORT DEVICE FOR MIRROR MILLING SWING HEAD

(71) Applicant: SHANGHAI TOP NUMERICAL CONTROL TECHNOLOGY CO., LTD., Shanghai (CN)

(72) Inventors: Yuhan WANG, Shanghai (CN); Bin YAO, Shanghai (CN); Lei ZHONG, Shanghai (CN); Yehui HU, Shanghai (CN)

(21) Appl. No.: 18/962,196

(22) Filed: Nov. 27, 2024

(30) Foreign Application Priority Data
Aug. 22, 2024 (CN) 2024111610902

(51) Int. Cl. B23Q 3/06

(52) U.S. Cl. CPC B23Q 3/062

(57) ABSTRACT

The present invention discloses an adaptive curved surface support device for a mirror milling swing head, relates to a technical field of part machining, comprises a fixing frame, a shell, a gimbal mechanism, a floating support mechanism and a plurality of springs, the shell is mounted at one end of the fixing frame, one end of the shell is provided with the universal mechanism and the floating support mechanism, the floating support mechanism is connected to the universal mechanism, the universal mechanism is used to make the floating support mechanism swing along circumferential direction, and the plurality of springs are arranged in the shell, the plurality of springs connect to the fixing frame and the floating support mechanism.

### CROSS-REFERENCE TO RELATED APPLICATION

This application claims priority to CN Application No. 2024111610902, filed Aug. 22, 2024, which is incorporated by reference herein in its entirety.

### BACKGROUND OF THE INVENTION

### 1. Field of the Invention

The present invention relates to the technical field of part machining, in particular to the adaptive curved surface support device for a mirror milling swing head.

### 2. Description of the Related Art

Milling of large-scale aviation thin-walled parts is one of the key technologies in aircraft fuselage manufacturing, and it has always been a difficult problem for manufacturing engineers. Aircraft skin is a typical aviation thin-walled part, it is an important part of the aircraft, belongs to the surface parts of the aircraft. The stress of the aircraft skin is complex, and the use environment is complex and harsh, so the processing requirements for the aircraft skin are very challenging. The traditional chemical milling method of aircraft skin has many processes, large pollution and low precision. In recent years, the emergence of a new green processing method, which is mirror milling, is a kind of machining method in which skin is suspension clamped, and the processing axis and the support axis are arranged on both sides of the skin to move synchronously. It is a combination of milling sagging, trimming, and drilling, can effectively improve the processing efficiency, is the future development trend of skin parts processing.

The prior art CN218855718U discloses a support end of a mirror milling device, the support end is connected to the front end of the support rod of the mirror milling device, and is used for supporting the workpiece to be processed. The body of the support end is a flat-head end cover structure, the rear end of the flat-head end cover has an end connected to the mirror milling device. There is a circular sag platform in the center of the front side end face of the flat-head end cover, and the center of the sag platform has a central water outlet hole that passes through the whole of the flat-head end cover. The other end of the water outlet hole is communicated with the water supply pipe of the mirror milling device, a plurality of sagging grooves are arranged around the sag platform of the front side of the flat-head end cover, the sagging groove is used for mounting eddy current sensors, a plurality of flat height plane rubber pads of equal height are fixed in the sagging platform of the front side of the flat-head end cover. There is a gap water groove between the plane rubber pads, and this gap water groove is communicated with the water outlet hole.

However, the user of mirror milling skin generally requires that the processing thickness error of the skin milling feature is within ±0.1 mm, and the supporting end in the prior art cannot float, so that the issue of the non-normal direction of the top brace of the supporting end occurs, and it is difficult to control the processing thickness error of the skin milling feature within ±0.1 mm.

### SUMMARY OF THE INVENTION

The purpose of the invention is to provide an adaptive curved surface support device for a mirror milling swing head, so as to solve the above mentioned technical issue.

The present invention adopts the following technical solution.

An adaptive curved surface support device for a mirror milling swing head, comprising: a fixing frame, a shell, a gimbal mechanism, a floating support mechanism and a plurality of springs, the shell is mounted at one end of the fixing frame, one end of the shell is provided with the universal mechanism and the floating support mechanism, the floating support mechanism is connected to the universal mechanism, the universal mechanism is used to make the floating support mechanism swing along circumferential direction, and the plurality of springs are arranged in the shell, the plurality of springs connect to the fixing frame and the floating support mechanism.

As preferred, the adaptive curved surface support device for a mirror milling swing head further comprising a swing sleeve, the swing sleeve is mounted in the shell, one end of the swing sleeve is connected to the fixing frame, and the other end of the swing sleeve is connected to the universal mechanism.

As further preferred, the adaptive curved surface support device for a mirror milling swing head further comprising a displacement sensor, and an outer wall of the swing sleeve is provided with the displacement sensor.

As further preferred, the adaptive curved surface support device for a mirror milling swing head further comprising a silica gel cover, one end of the silica gel cover is mounted on the shell, and the other end of the silica gel cover is connected to the floating support mechanism.

As further preferred, the floating support mechanism comprises a backing plate and a sliding piece, the backing plate is mounted in the silica gel cover, the other end of the silica gel cover is connected to the backing plate, and the backing plate is sleeved on the outer side of the sliding piece.

As further preferred, the floating support mechanism further comprises a jacking end cover and a first gland, the jacking end cover is arranged at one end of the sliding piece, the periphery of the sliding piece is provided with a first gland, the first gland is connected to the backing plate.

As further preferred, the universal mechanism comprises a bearing base, a bearing inner ring, a ball retainer and a plurality of steel balls, the bearing base is fixedly connected to the swing sleeve and is positioned at the periphery of the sliding piece, the ball retainer is arranged in the bearing base, the plurality of steel balls is arranged in the ball retainer, one side of the bearing base, which faces the backing plate, is provided with a bearing inner ring, and the bearing inner ring is connected to the backing plate, the bearing inner ring is in contact with the plurality of steel balls, one end of the plurality of springs is connected to the bearing inner ring, and the other end of the plurality of springs is connected to the fixing frame.

As further preferred, one side of the bearing inner ring, which faces the plurality of steel balls, is provided with an inclined guide surface, and the guide surface is in contact with the plurality of steel balls.

As further preferred, the backing plate is provided with an air hole, and the air hole is communicated with the inside of the sliding piece, so as to provide compressed air to the inside of the sliding piece As further preferred, one end of the swing sleeve is provided with a first aperture step, a second aperture step is arranged on the fixing frame, and the first aperture step is closely fitted with the second aperture step.

The above technical solution has the following advantages or benefit effects:
(1) in the invention, by setting the universal mechanism, the floating support mechanism can be made to swing along circumferential direction, the issue of the non-normal direction of the floating support mechanism can be avoided during processing;
(2) in the invention, by setting the springs, the floating support mechanism can be automatically reset, so that the floating support mechanism can springback to the original position after the swing;
(3) in the invention, by setting the floating support mechanism, the skin can be avoided from vibrating during processing;
(4) in the invention, by setting the silica gel cover, the circumferential swing of the floating support mechanism would not be limited, at the same time, the floating support mechanism has the function of waterproof and dustproof during the swing.

### BRIEF DESCRIPTION OF THE DRAWINGS

FIG. 1 is a schematic diagram of the structure of the adaptive curved surface support device for a mirror milling swing head in the invention;

FIG. 2 is a schematic diagram of the back structure of the adaptive curved surface support device for a mirror milling swing head in the invention;

FIG. 3 is a schematic diagram of the section of the adaptive curved surface support device for a mirror milling swing head in the invention;

FIG. 4 is a schematic diagram of the explosion of the universal mechanism in the invention.

In the figure: 1, fixing frame; 2, shell; 3, gimbal mechanism; 301, bearing base; 302, bearing inner ring; 303, ball retainer; 304, steel ball; 4, floating support mechanism; 401, backing plate; 402, jacking end cover; 403, first gland; 404, second gland; 405, fixing sleeve; 406, sliding sleeve; 5, spring; 6, silica gel cover; 7, swing sleeve.

### DETAILED DESCRIPTION

The technical solution of the present invention will be clearly and completely described below in conjunction with the accompanying drawings, and it is obvious that the described embodiments are part rather than all of the embodiments of the present invention. Based on the embodiments in the present invention, all other embodiments obtained by a person skilled in the art without making creative labor belong to the scope of protection of the present invention.

In the description of the present invention, it should be noted that if the terms “center,” “up,” “down,” “left,” “right,” “vertical,” “horizontal,” “inner,” “outer,” etc., appear, the orientation or positional relationship indicated by it is based on the orientation or positional relationship shown in the accompanying drawing, and is only for the convenience of describing the invention and simplifying the description, and does not indicate or imply that the device or element referred to must have a specific orientation, be constructed and operated in a specific orientation, and therefore cannot be understood as a limitation of the present invention. In addition, the terms “first”, “second”, “third” are used for descriptive purposes only and should not be construed as indicating or implying relative importance.

In the description of the present invention, it should be noted that, unless otherwise expressly specified and limited, the terms “mounted,” “connected,” “coupled” shall be understood broadly, for example, they may be fixed, detachable, or integrally connected; it can be mechanically or electrically connected; it can be directly connected or indirectly connected through an intermediate medium, or it can be a communication between two components. For those skilled in the art, the specific meaning of the above terms in the present invention can be understood on a case-by-case basis.

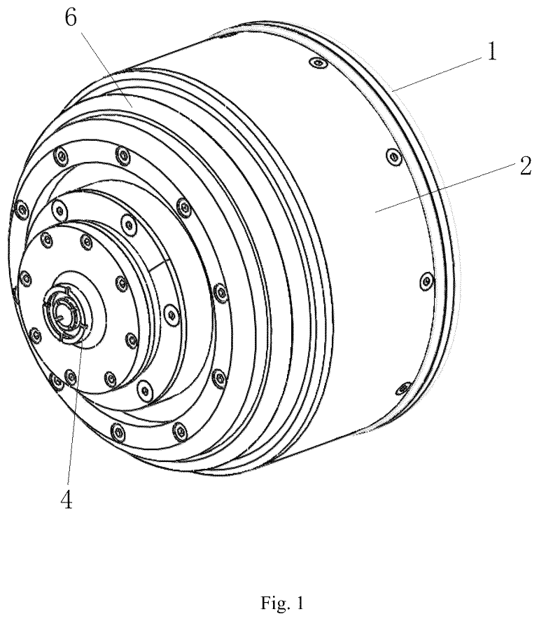

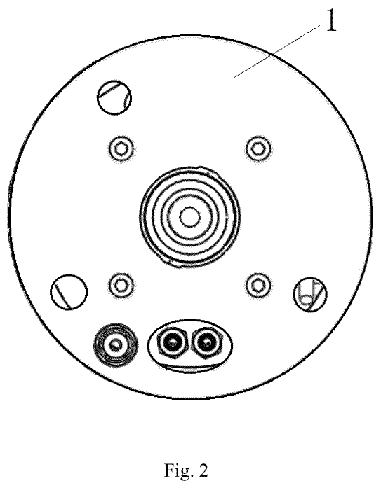

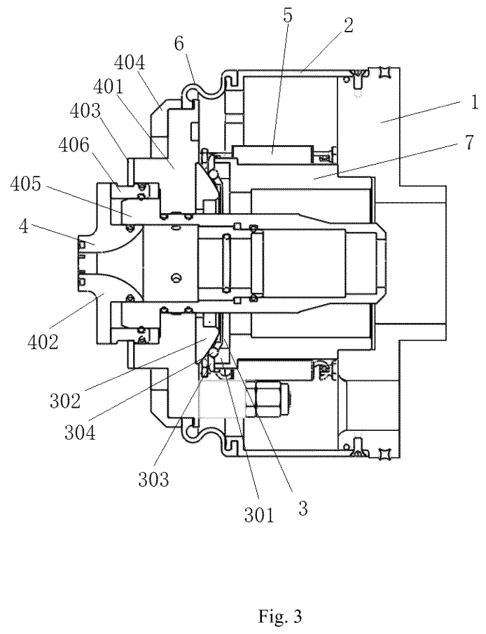

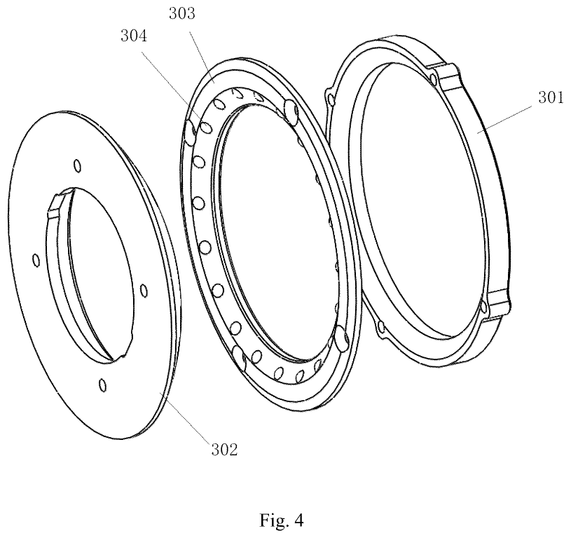

FIG. 1 is a schematic diagram of the structure of the adaptive curved surface support device for a mirror milling swing head in the invention; FIG. 2 is a schematic diagram of the back structure of the adaptive curved surface support device for a mirror milling swing head in the invention; FIG. 3 is a schematic diagram of the section of the adaptive curved surface support device for a mirror milling swing head in the invention; FIG. 4 is a schematic diagram of the explosion of the universal mechanism in the invention. Referring to FIG. 1 to FIG. 4, there is shown a preferred embodiment, in which an adaptive curved surface support device for a mirror milling swing head, comprising: a fixing frame 1, a shell 2, a gimbal mechanism 3, a floating support mechanism 4 and the plurality of springs 5, the shell 2 is mounted at one end of the fixing frame 1, one end of the shell 2 is provided with the universal mechanism 3 and the floating support mechanism 4, the floating support mechanism 4 is connected to the universal mechanism 3, the universal mechanism 3 is used to make the floating support mechanism swing 4 along circumferential direction, and the plurality of springs 5 are arranged in the shell 2, the plurality of springs 5 connect to the fixing frame 1 and the floating support mechanism 4. In the embodiment, the shell 2 is made of aluminum alloy, the shell 2 and the fixing frame 1 can be connected through the countersunk screw, a seal ring is provided between the counter sunk screw and the shell 2 so as to be sealed and to be waterproof and dustproof. The fixing frame 1 is used to threadedly connect to the W axis, which is on the rear end of the swing head, the threaded connection therebetween is provided with a thread glue, so as to prevent from loosing and strengthen the fixing. Referring to FIG. 3, on the other end of the fixing frame 1, there is provided a projection structure. Tn external thread is arranged on the outer wall of the projection structure, the external thread is used to threadedly connect the W axis which is on the rear end of the swing end. While the outer wall of the fixing frame 1 can be slidably rubbed with the wall of the box hole of the swing head, the fixing frame 1 can move with the movement of the W axis. A seal ring is provided between the fixing frame 1 and the wall of the box hole. It is ensured that the moisture and dust cannot enter into the inside of the box of the swing head through the sliding gap when sliding, there are W axis motor and other electronic elements in the inside of the box of the swing head.

In the embodiment, the universal mechanism 3 is arranged on one end of the shell 2, and is fitted with the silica gel cover. By setting the universal mechanism 3, the floating support mechanism 4 is facilitated to swing along circumferential direction, the issue of the non-normal direction of the floating support mechanism 4 can be avoided. The plurality of springs 5 are annularly distributed, and the plurality of springs 5 are connected to the floating support mechanism 4 so as to pull the floating support mechanism 4, so that the floating support mechanism 4 can restore to the original position after the swing.

The floating support mechanism 4 can be expanded and retracted in axial direction, so that the vibrating of the skin can be restrained during processing.

Furthermore, as a preferred embodiment, the adaptive curved surface support device for a mirror milling swing head further comprises a swing sleeve 7, the swing sleeve 7 is mounted in the shell 2, one end of the swing sleeve 7 is connected to the fixing frame 1, and the other end of the swing sleeve 7 is connected to the universal mechanism 3. Referring to FIG. 3, the inside of the swing sleeve 7 is hollow, so that a probe and the fastener thereof can be swing in the hollow of the swing sleeve 7, and the outer wall of one end of the swing sleeve 7 is provided with a first aperture step, a location hole is arranged on one end of the fixing frame 1, a second aperture step is arranged on the periphery of the open of the location hole, the first aperture step is closely fitted with the second aperture step, so as to locate the swing sleeve 7. Then the swing sleeve 7 is connected and fixed to the fixing frame 1 through the screw, so that the mounting accuracy and firm degree is ensured. A cutting sleeve is arranged in the inside of the location hole, the cutting sleeve extrudes the swing sleeve 7, so that the first aperture step of the swing sleeve 7 can be closely contacted to the second aperture step of the fixing frame 1.

In this embodiment, as referring to FIG. 2, a plurality of holes are arranged in the corresponding positions of the fixing frame 1, so that the air pipe, water pipe, and electric wires, etc., can pass through the fixing frame 1 through the holes.

As referring to FIG. 3, the plurality of springs 5 are annularly distributed on the periphery of the swing sleeve 7.

Further, as a preferred embodiment, the adaptive curved surface support device for a mirror milling swing head further comprises a displacement sensor, and an outer wall of the swing sleeve 7 is provided with the displacement sensor. The arranged displacement sensor can be connected to the external controller. The displacement sensor is configured to monitor the swing displacement of the backing plate 401, and to calculate the swing angle of the floating support mechanism 4 through the external controller.

Further, as a preferred embodiment, the adaptive curved surface support device for a mirror milling swing head further comprises a silica gel cover 6, one end of the silica gel cover 6 is mounted on the shell 2, and the other end of the silica gel cover 6 is connected to the floating support mechanism 4. In the embodiment, as referring to FIG. 3, a groove is arranged on the outer wall of one end of the shell 2, the silica gel cover 6, by the clamp force generated from the deformation itself, clamps in the groove of the shell 2, so as to be dustproof and be sealed.

Further, as a preferred embodiment, the floating support mechanism 4 comprises a backing plate 401 and a sliding piece, the backing plate 401 is mounted in the silica gel cover 6, the other end of the silica gel cover 6 is connected to the backing plate 401, and the backing plate 401 is sleeved on the outer side of the sliding piece. The floating support mechanism 4 further comprises a second gland 404, as referred to FIG. 3, the second gland 404 is used to compress the other end of the silica gel cover 6, then the second gland 404 is connected to the backing plate 401 through the screw, so that the other end of the silica gel cover 6 can be connected to the backing plate 401, so that the silica gel cover 6 can be deformed following the swing of the backing plate 401.

Further, as a preferred embodiment, the floating support mechanism 4 further comprises a jacking end cover 402 and a first gland 403, the jacking end cover 402 is arranged at one end of the sliding piece, the periphery of the sliding piece is provided with a first gland 403, the first gland 403 is connected to the backing plate 401. As referred to FIG. 3, the sliding piece comprises a fixing sleeve 405 and a sliding sleeve 406 arranged on the periphery of one end of the fixing sleeve 405. A seal ring is arranged between the sliding sleeve 406 and the fixing sleeve 405 so as to seal the sliding sleeve 406 and the fixing sleeve 405. The jacking end cover 402 is connected and fixed to the sliding sleeve 406, a part of the jacking end cover 402 is entered into the fixing sleeve 405, and is sealed with the fixing sleeve 405 through a seal ring. A limit slot is arranged on the outer wall of the sliding sleeve 406. After the first gland 403 is connected and fixed to the backing plate 401 through the screw, a part of the inner wall of the first gland 403 is entered into the limit slot, so as to avoid the detachment of the sliding sleeve 406 from the fixing sleeve 405. The backing plate 401 is provided with an air hole, and the air hole is communicated with the inside of the sliding piece and is used to provide compressed air to the inside of the sliding piece. Specifically, the air hole of the backing plate 401 is communicated with the inner chamber of the fixing sleeve 405, so as to form the air pressure chamber, the air hole of the backing plate 401 is connected to the external air pump, so as to pump the compressed air into the inside of the air pressure chamber, so as to push the jacking end cover to bring the sliding sleeve 406 to slide, the various air pressure can be supplied, so as to control the jacking force of the jacking end cover 402.

During the process of skin, the force of jacking skin is changed, so that the jacking end cover 402 is moved in a direction adjacent to the fixing sleeve 405. However, as the compressed air supplies the push, the position of the sliding sleeve 406 is adaptively floated. Meanwhile, the jacking end cover 402 swings as the backing plate 401 swings, it provides a push and performs the adaptively swing according to the direction to be processed at the same time.

Further, as a preferred embodiment, the universal mechanism 3 comprises a bearing base 301, a bearing inner ring 302, a ball retainer 303 and a plurality of steel balls 304, the bearing base 301 is fixedly connected to the swing sleeve 7 and is positioned at the periphery of the sliding piece, the ball retainer 303 is arranged in the bearing base 301, the plurality of steel balls 304 is arranged in the ball retainer 303, one side of the bearing base 301, which faces the backing plate 401, is provided with a bearing inner ring 302, and the bearing inner ring 302 is connected to the backing plate 401, the bearing inner ring 302 is in contact with the plurality of steel balls 304, one end of the plurality of springs 5 is connected to the bearing inner ring 302, and the other end of the plurality of springs 5 is connected to the fixing frame 1. One side of the bearing inner ring 302, which faces the plurality of steel balls 304, is provided with an inclined guide surface, and the guide surface is in contact with the plurality of steel balls 304. As referred to FIG. 3, the bearing base 301 is connected to the other end of the swing sleeve 7 through a screw. The swing sleeve 7 does not swing at an angle, it just can move when the W axis moves. The plurality of steel balls 304 are arranged in the ball retainer 303, and are centered by the ball retainer 303, so that the plurality of steel balls 304 can roll in the ball retainer 303. The bearing inner ring 302 is connected and fixed to the backing plate 401 through a screw.

When the jacking end cover 402 swings, the backing plate 401 is driven to swing, thus the bearing inner ring 302 is driven to swing. As the guide surface is in contact with the plurality of steel balls 304, the bearing inner ring 302 swings. Both ends of the plurality of springs 5 can connect to the fixing frame 1 and the backing plate 401 respectively, the plurality of springs 5 can act as tension springs to tension the backing plate 401, so that the backing plate 401 to bring the bearing inner ring 302 to compress the plurality of steel balls 304, to ensure the bearing base 301, the bearing inner ring 302, the ball retainer 303 and the plurality of steel balls 304 are not disengaged.

When the backing plate 401 swings, the plurality of springs 5 provide a resilience force on the backing plate 401. Regardless of the angle to which the backing plate 401 swings, there is always a spring 5 that can provide tension for the backing plate 401, so that the swung backing plate 401 can restore to the original position in time.

As referred to FIG. 3, the other end of the swing sleeve 7 is provided with a first location hole, which is fitted with the bearing base 301. The inner wall of the first location hole is closely contacted with the outer wall of the bearing base 301, so as to be centered to ensure the accuracy of the mounting. A second location hole, which is used to be fitted with the bearing inner ring 302, is arranged on the backing plate 401. The inner wall of the second location hole is closely contacted with the outer wall of the bearing inner ring 302, so as to be centered to ensure the accuracy of the mounting.

The above is only a preferred embodiment of the present invention, and does not intend to limit the embodiment and scope of protection of the present invention, and those skilled in the art should be able to realize that all solutions obtained by equivalent substitutions and obvious changes made by using the contents of the description and illustrations shall be included in the scope of protection of the present invention.

What is claimed is:

1. An adaptive curved surface support device for a mirror milling swing head, comprising: a fixing frame, a shell, a gimbal mechanism, a floating support mechanism and a plurality of springs, the shell is mounted at one end of the fixing frame, one end of the shell is provided with the universal mechanism and the floating support mechanism, the floating support mechanism is connected to the universal mechanism, the universal mechanism is used to make the floating support mechanism swing along circumferential direction, and the plurality of springs are arranged in the shell, the plurality of springs connect to the fixing frame and the floating support mechanism.

2. The adaptive curved surface support device for a mirror milling swing head of claim 1, further comprising a swing sleeve, the swing sleeve is mounted in the shell, one end of the swing sleeve is connected to the fixing frame, and the other end of the swing sleeve is connected to the universal mechanism.

3. The adaptive curved surface support device for a mirror milling swing head of claim 2, further comprising a displacement sensor, and an outer wall of the swing sleeve is provided with the displacement sensor.

4. The adaptive curved surface support device for a mirror milling swing head of claim 2, further comprising a silica gel cover, one end of the silica gel cover is mounted on the shell, and the other end of the silica gel cover is connected to the floating support mechanism.

5. The adaptive curved surface support device for a mirror milling swing head of claim 4, wherein the floating support mechanism comprises a backing plate and a sliding piece, the backing plate is mounted in the silica gel cover, the other end of the silica gel cover is connected to the backing plate, and the backing plate is sleeved on the outer side of the sliding piece.

6. The adaptive curved surface support device for a mirror milling swing head of claim 5, wherein the floating support mechanism further comprises a jacking end cover and a first gland, the jacking end cover is arranged at one end of the sliding piece, the periphery of the sliding piece is provided with a first gland, the first gland is connected to the backing plate.

7. The adaptive curved surface support device for a mirror milling swing head of claim 5, wherein the universal mechanism comprises a bearing base, a bearing inner ring, a ball retainer and a plurality of steel balls, the bearing base is fixedly connected to the swing sleeve and is positioned at the periphery of the sliding piece, the ball retainer is arranged in the bearing base, the plurality of steel balls is arranged in the ball retainer, one side of the bearing base, which faces the backing plate, is provided with a bearing inner ring, and the bearing inner ring is connected to the backing plate, the bearing inner ring is in contact with the plurality of steel balls, one end of the plurality of springs is connected to the bearing inner ring, and the other end of the plurality of springs is connected to the fixing frame.

8. The adaptive curved surface support device for a mirror milling swing head of claim 7, wherein one side of the bearing inner ring, which faces the plurality of steel balls, is provided with an inclined guide surface, and the guide surface is in contact with the plurality of steel balls.

9. The adaptive curved surface support device for a mirror milling swing head of claim 5, wherein the backing plate is provided with an air hole, and the air hole is communicated with the inside of the sliding piece, so as to provide compressed air to the inside of the sliding piece.

10. The adaptive curved surface support device for a mirror milling swing head of claim 2, wherein one end of the swing sleeve is provided with a first aperture step, a second aperture step is arranged on the fixing frame, and the first aperture step is closely fitted with the second aperture step.
